(19) United States
(12) Patent Application Publication
(10) Pub. No.: US 2016/0034976 A1
(43) Pub. Date: Feb. 4, 2016

(54) ADVERTISEMENT PRESENTATION

(71) Applicant: Yahoo!, Inc., Sunnyvale, CA (US)

(72) Inventors: Dinoop Dayanand, Bengaluru (IN); Samiksha Harish Kothari, Mumbai, IN (US)

(21) Appl. No.: 14/447,861

(22) Filed: Jul. 31, 2014

(51) Int. Cl. G06Q 30/02; G06F 3/0484; G06F 3/0485

(52) U.S. Cl. CPC G06Q 30/0277; G06F 3/0485; G06F 3/04842

(57) ABSTRACT

Scroll input received with regard to content within a content layer (e.g., email content displayed through an email inbox content layer of an email application) may be used as a trigger to reveal an advertisement layer or portion thereof, where the advertisement layer is under the content layer. For example, as a user scrolls towards the end of the email content, display of the email inbox content layer may be contracted and display of an advertisement layer may be expanded. In this way, one or more advertisement layers, comprising advertisements, may be displayed based upon scroll input. In an example, an advertisement may be revealed (e.g., gradually as the user scrolls towards the end of content) such that the advertisement does not occlude or visually block the content.

### BACKGROUND

Many content providers, applications, and/or websites provide advertisement opportunities. In an example, a video streaming content provider may provide video advertisement opportunities. In another example, a website may provide imagery advertisement opportunities. Many advertisements may be intrusive to the content being consumed by the user. For example, an advertisement may be displayed as a pop-up overlaid on an article being read by the user. Such obstruction of content may be exacerbated on mobile devices with relatively smaller screens.

### SUMMARY

In accordance with the present disclosure, a first scroll input of content within a content layer may be identified. The content layer may be overlaid an advertisement layer. An advertisement preview of the advertisement layer may be displayed though an advertisement presentation window based upon the first scroll input. The advertisement preview may comprise a first portion of the advertisement layer. Responsive to identifying a second scroll input of the content, a second portion of the advertisement layer may be displayed through the advertisement presentation window.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an exemplary configuration of a server that may utilize and/or implement at least a portion of the techniques presented herein.

FIG. 3 is an illustration of a scenario involving an exemplary configuration of a client that may utilize and/or implement at least a portion of the techniques presented herein.

FIG. 4 is a flow chart illustrating an exemplary method of advertisement presentation.

FIG. 5A is a component block diagram illustrating an exemplary system for advertisement presentation where a content layer is overlaid an advertisement layer.

FIG. 5B is a component block diagram illustrating an exemplary system for advertisement presentation where a content layer is overlaid an advertisement layer and a second advertisement layer.

FIG. 5C is a component block diagram illustrating an exemplary system for advertisement presentation where a content layer and a task interface are overlaid an advertisement layer and a second advertisement layer.

FIG. 5D is a component block diagram illustrating an exemplary system for advertisement presentation where a content layer is displayed.

FIG. 5E is a component block diagram illustrating an exemplary system for advertisement presentation where a first portion of an advertisement layer is revealed.

FIG. 5F is a component block diagram illustrating an exemplary system for advertisement presentation where a second portion of an advertisement layer is revealed.

FIG. 5G is a component block diagram illustrating an exemplary system for advertisement presentation where an advertisement layer is revealed.

FIG. 5H is a component block diagram illustrating an exemplary system for advertisement presentation where a second advertisement layer is revealed.

FIG. 6A is an example of revealing an advertisement layer.

FIG. 6B is an example of revealing an advertisement layer.

FIG. 7 is an illustration of a scenario featuring an exemplary nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

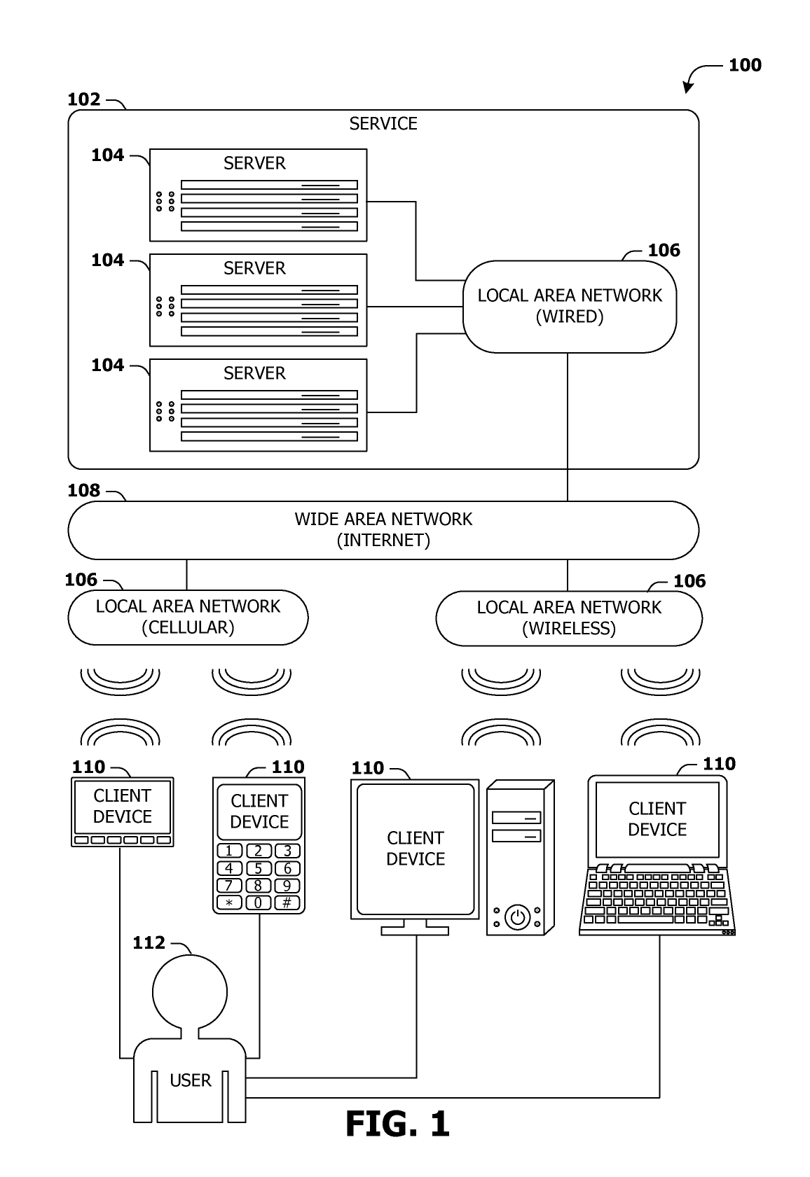

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

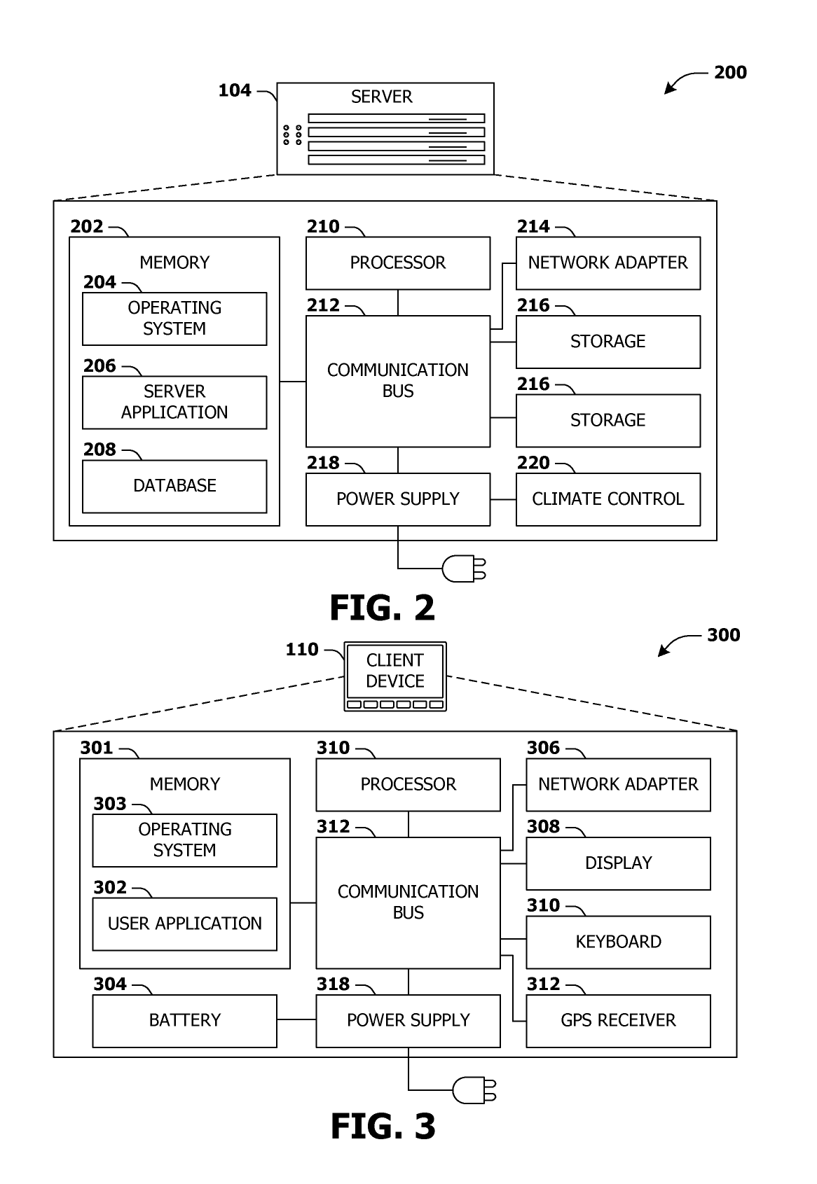

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectable to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectable to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more techniques and/or systems for advertisement presentation are provided herein. Many users may interact with content by scrolling. For example, a user may scroll through a list of movies available from a video streaming service. Accordingly, advertisements may be provided based upon scroll input associated with content, which may provide a non-intrusive advertisement experience while efficiently utilizing screen real estate (e.g., as opposed to displaying fixed banner ads that may occupy a substantial portion of screen real estate and/or displaying pop-ups that obscure and/or occlude the user's ability to view the content). For example, a content layer, comprising content, (e.g., an email inbox interface comprising email content) may be overlaid an advertisement layer comprising an advertisement. As the user scrolls through the content, a position of the content layer may be adjusted to reveal the advertisement layer or portions thereof (e.g., as the user scrolls to the bottom or top of the email content, portions of the advertisement layer may be revealed until the entire advertisement layer is revealed). In this way, the user may view the email content without obstruction, and the user's natural tendency to scroll through content may be used as a trigger to reveal advertisements.

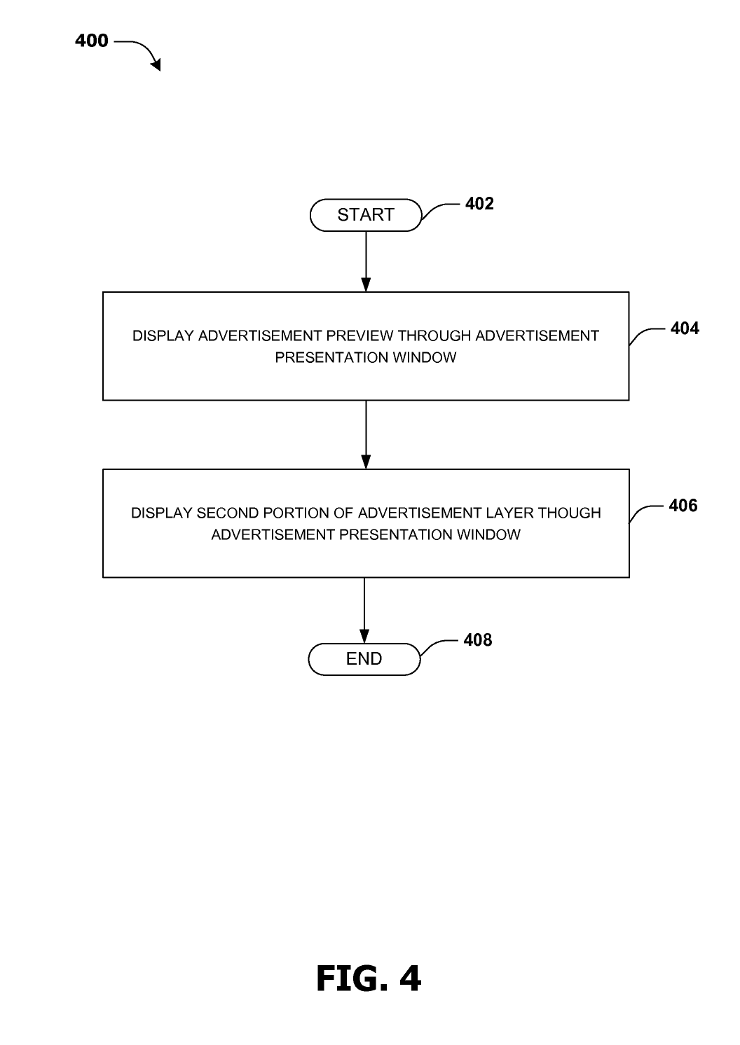

An embodiment of advertisement presentation is illustrated by an exemplary method 400 of FIG. 4. At 402, the method starts. A content layer may correspond to a content interface, such as a user interface, through which content is displayed (e.g., a website, an email application, a videogame, a list of images, an article, a video streaming service, or any other application or interface). For example, a movie content layer may be populated with movie list content that a user may browse for purchase. The content layer may be overlaid an advertisement layer comprising an advertisement (e.g., the content layer initially hide the advertisement layer or a portion thereof). Portions of the advertisement layer may be revealed/displayed through an advertisement presentation window based upon scroll input of the content (e.g., as the user scrolls towards an end of the movie list content, portions of the advertisement layer may be revealed). In an example, a first direction of scroll input of the content (e.g., up, down, left, right, or any other scroll direction) may be mapped to expansion of the advertisement presentation window for displaying an increasing amount of the advertisement layer. In another example, a second direction of scroll input of the content (e.g., up, down, left, right, or any other scroll direction different than the first direction) may be mapped to contraction of the advertisement presentation window for displaying a deceasing amount of the advertisement layer.

In an example, the advertisement presentation window may be displayed after an ending edge of the content layer (e.g., after the end of the movie list content, such that scroll input towards the end of the movie list content results in the advertisement layer being revealed through the advertisement presentation window). In another example, the advertisement presentation window may be displayed before a starting edge of the content layer (e.g., before the start of the movie list content, such that scroll input towards the start of the movie list content results in the advertisement layer being revealed through the advertisement presentation window). In an example, the advertisement presentation window may be displayed between a task interface and either the ending edge of the content layer or the starting edge of the content layer (e.g., the advertisement layer may be revealed between the end of the movie list content and a movie task interface associated with various movie functionality).

At 404, a first scroll input of the content may be identified. For example, the user may start scrolling through the movie list content. Accordingly, an advertisement preview of the advertisement layer may be displayed through the advertisement presentation window based upon the first scroll input. The advertisement preview may comprise a first portion of the advertisement layer. For example, the advertisement layer may comprise a Paris vacation advertisement, and the first portion may comprise promotional text “Take a vacation to the Eiffel tower” that is located below a depicting of the Eiffel tower. In an example, a position of the content layer may be adjusted to reveal the first portion of the advertisement layer (e.g., the content layer may be shifted up such that a top portion of the movie list content becomes invisible due to a top portion of the content layer being shifted up off the screen) based upon the first scroll input.

At 406, a second scroll input of the content may be identified. For example, the user may further scroll towards the end of the movie list content. Accordingly, a second portion of the advertisement layer (e.g., and the first portion of the advertisement layer) may be displayed through the advertisement presentation window. For example, the promotional text and the Eiffel tower of the Paris vacation advertisement may be revealed. In an example, the position of the content layer may be adjusted to reveal the second portion of the advertisement layer (e.g., the content layer may be further shifted up such that a middle portion of the movie list content becomes invisible due to a middle portion of the content layer being shifted up off the screen) based upon the second scroll input. Sound and/or motion associated with the advertisement layer may be provided through the advertisement presentation window (e.g., an audio message for the Paris vacation advertisement may be played once a threshold amount of the advertisement layer has been revealed).

In an example, visualization of the advertisement presentation window may be configured according to an elastic configuration (e.g., more or less of the advertisement layer may be revealed based upon expansion or contraction of the advertisement presentation window resulting from various forms of scroll input). For example, the advertisement presentation window may be visually contracted to display a decreasing amount of the advertisement layer based upon an occurrence of a scroll release input (e.g., occurring before an advertisement reveal scroll threshold has been satisfied, which may otherwise transition the advertisement presentation window to display a full view of the advertisement layer). In another example, the advertisement layer may be displayed through the advertisement presentation window (e.g., a full view of the entire advertisement layer) based upon satisfaction of the advertisement reveal scroll threshold and/or based upon a scroll release input being identified after the satisfaction of the advertisement reveal scroll threshold (e.g., the user scrolls to the end of the movie list content, and then the user stops scrolling). Responsive to receiving a dismiss input (e.g., while the full view of the advertisement layer is being displayed), the advertisement presentation window may be visually contracted to display a decreasing amount of the advertisement layer.

In an example, a set of advertisement layers may be generated and/or overlaid with respect to one another, and the content layer may be overlaid the set of advertisement layers. For example, the advertisement layer may be overlaid a second advertisement layer. Responsive to identifying scroll input associated with the advertisement presentation window (e.g., the user attempts to scroll past the advertisement layer displayed through the advertisement presentation window), display of the advertisement layer through the advertisement presentation window may be contracted, and display of the second advertisement layer through the advertisement presentation window may be expanded. In an example, the advertisement layers, within the set of advertisement layers, may be ordered according to a visual story telling ordering (e.g., a flight advertisement, then a car rental advertisement, then a hotel advertisement, and then an amusement park advertisement). A first direction of scroll input may be mapped for the advertisement presentation window to sequentially reveal advertisement layers of the set of advertisement layers based upon the visual story telling ordering. At 408, the method ends.

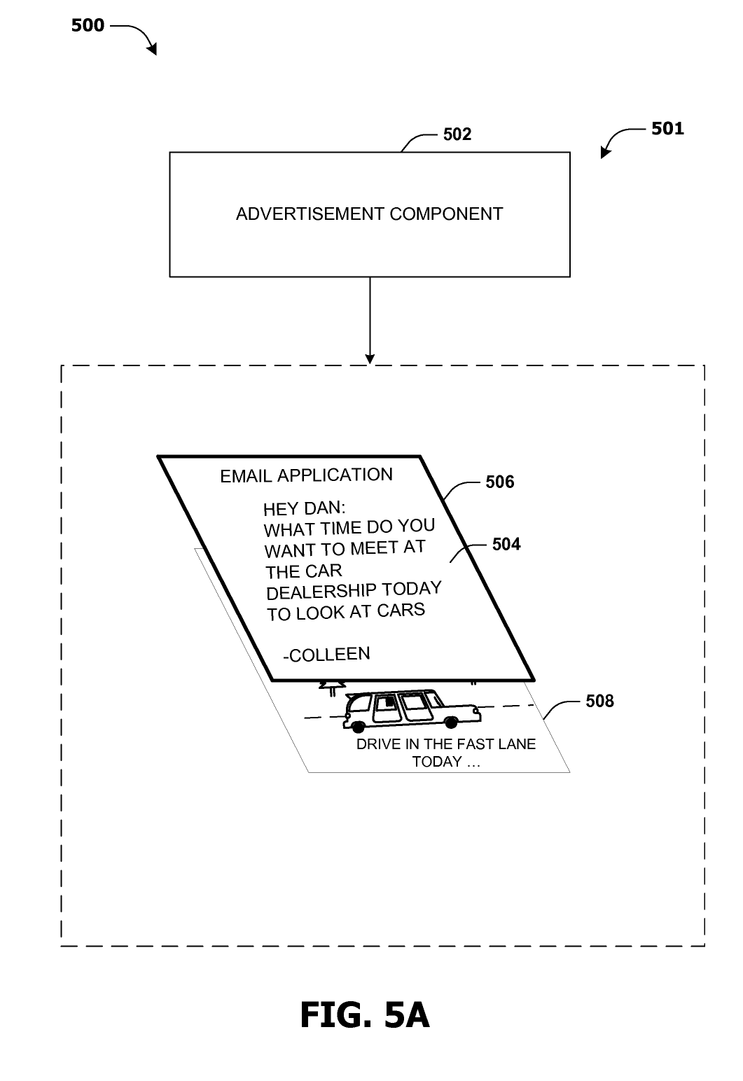

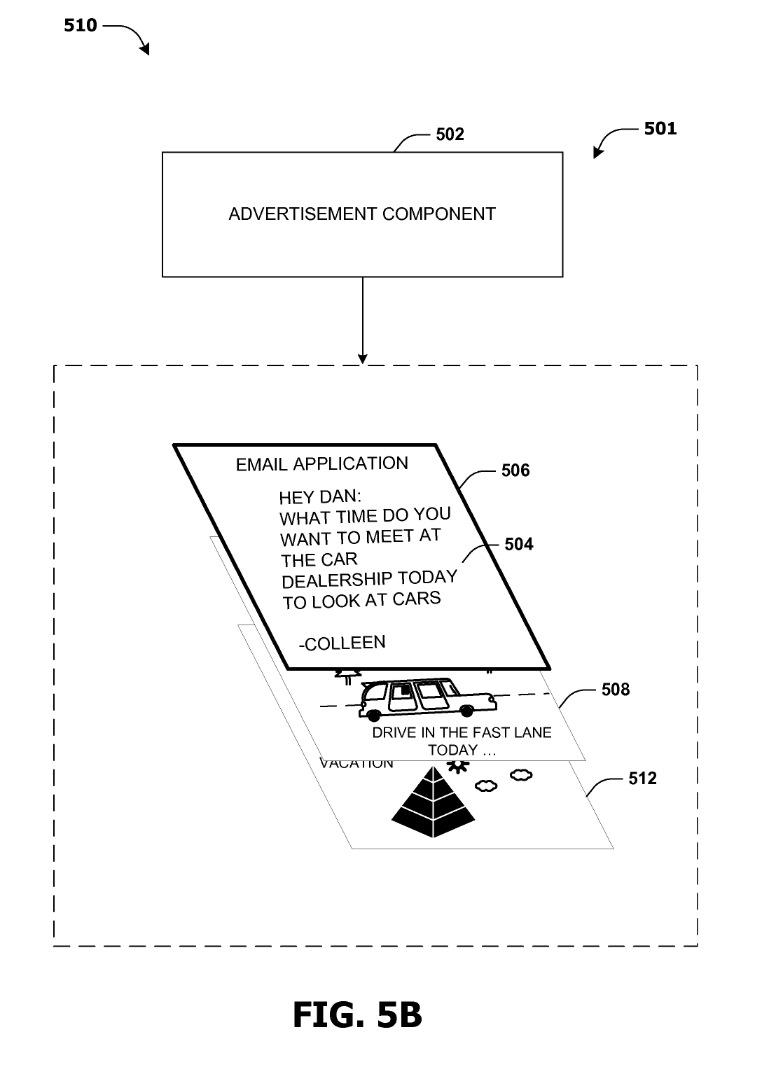

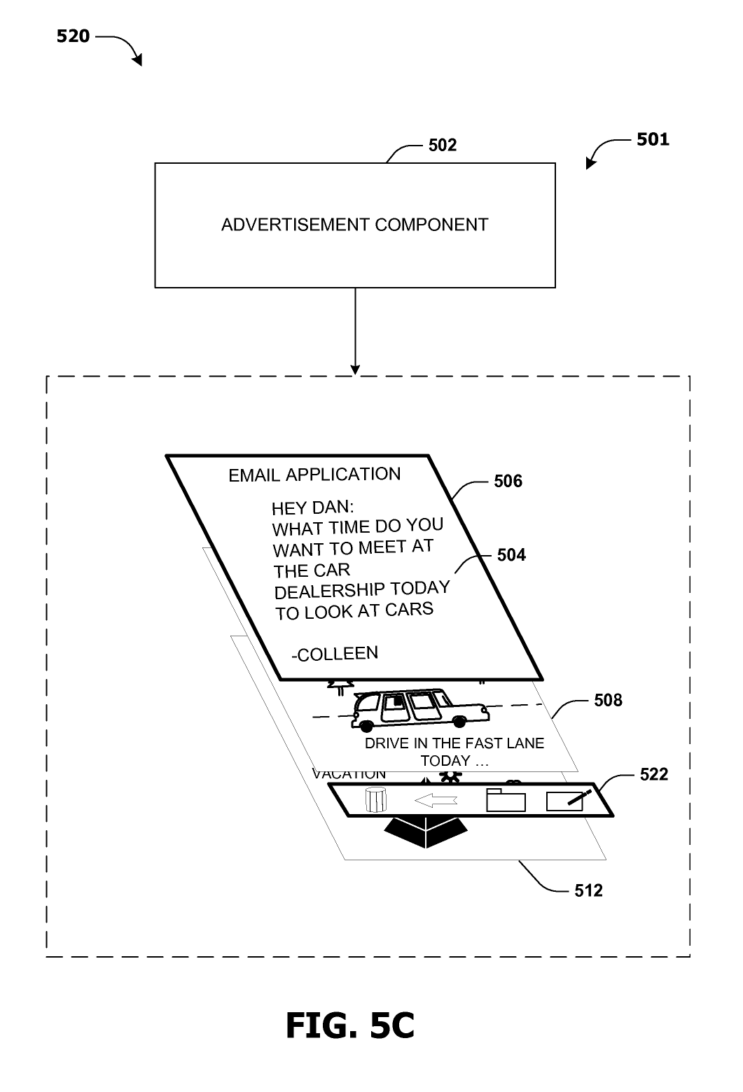

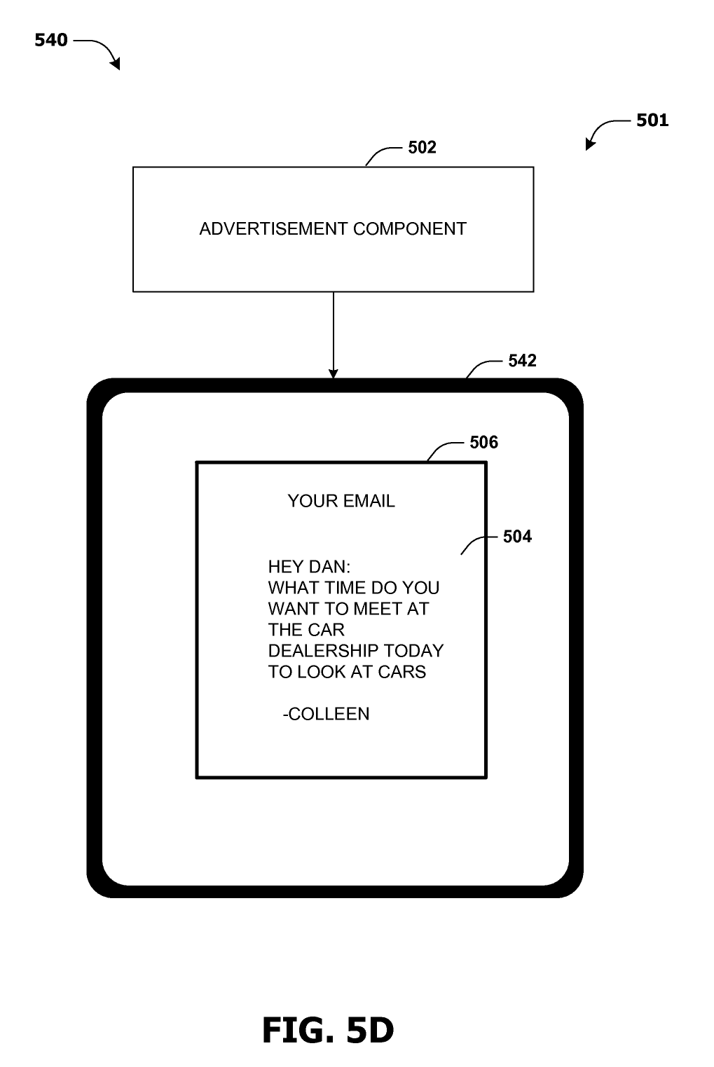

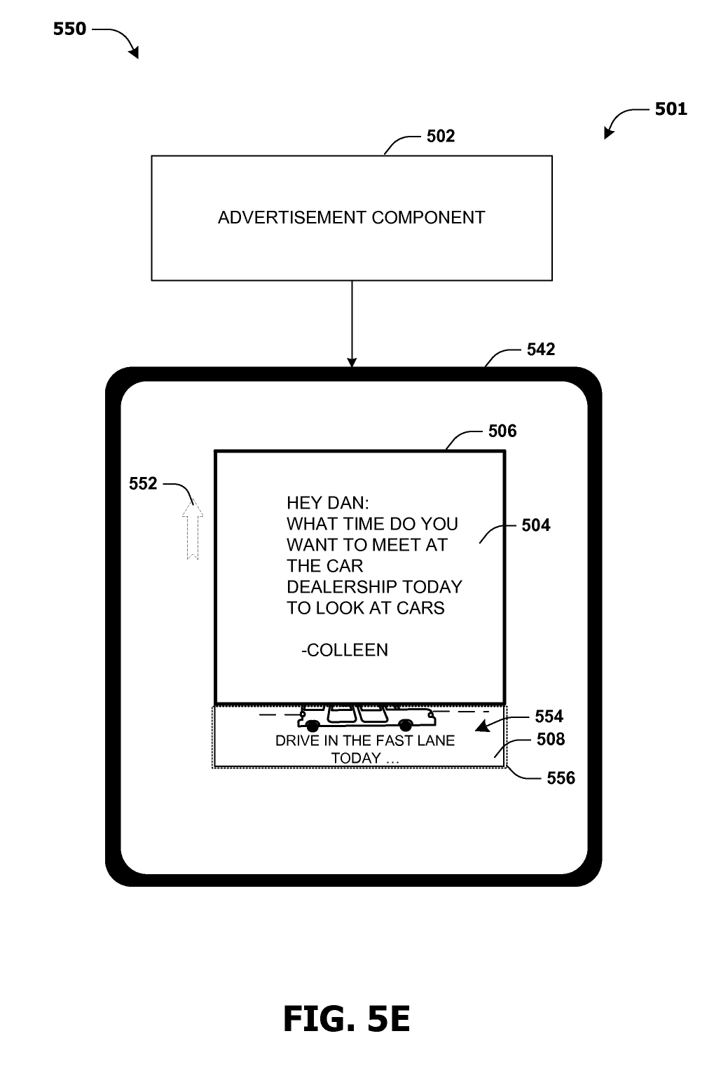

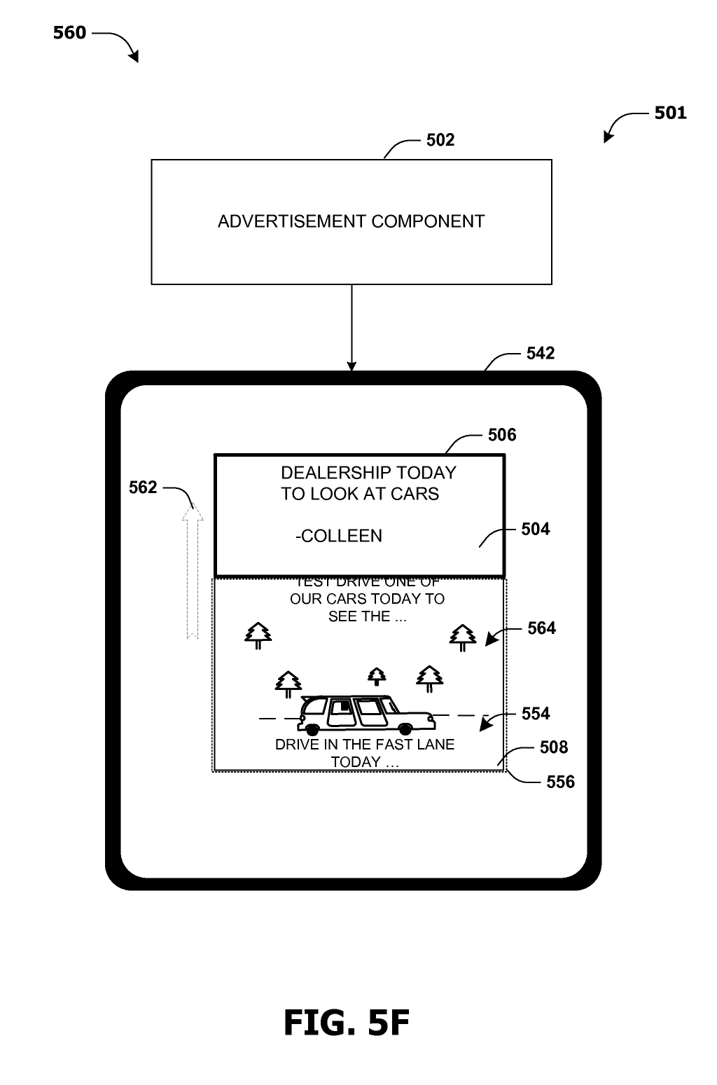

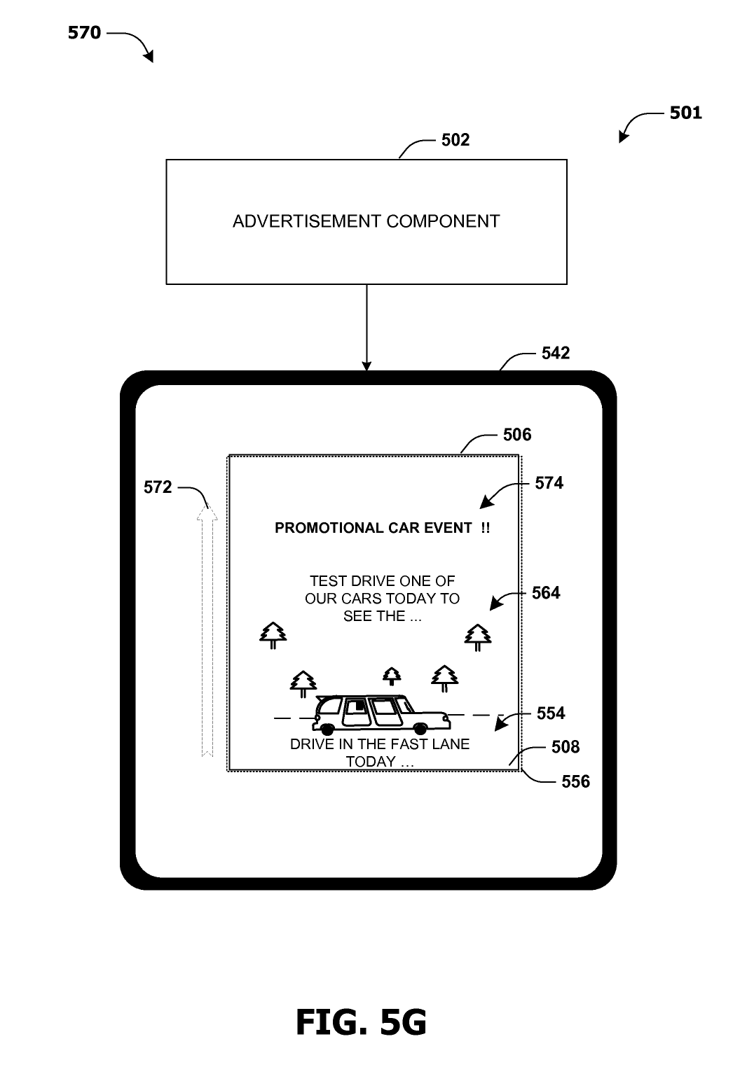

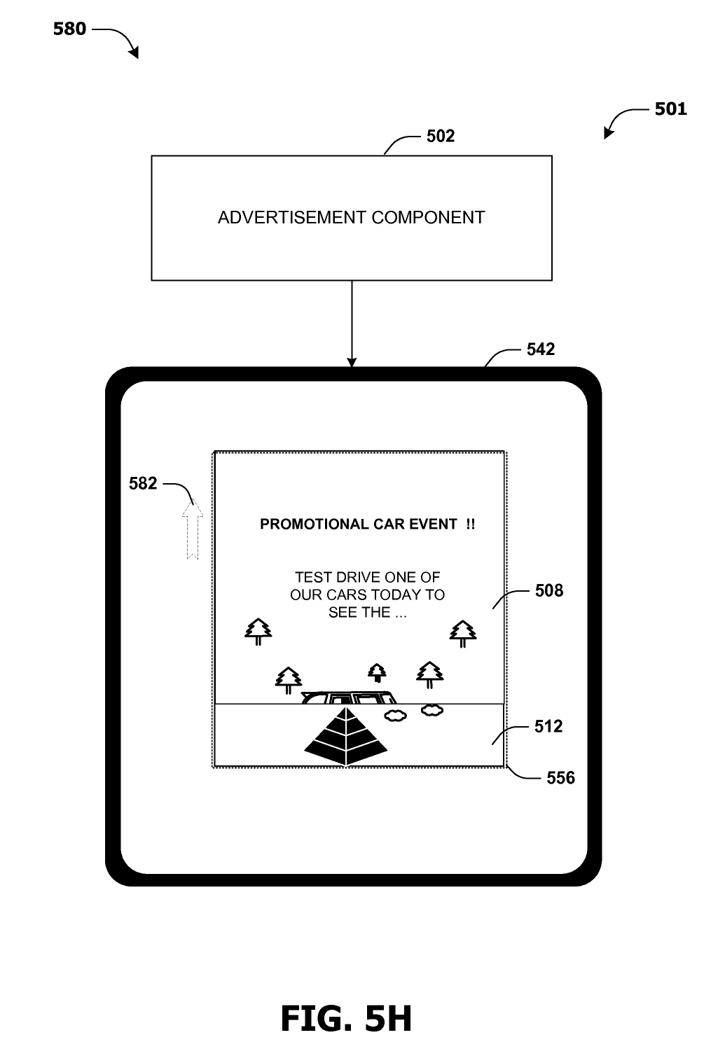

FIGS. 5A-5H illustrate examples of a system 501, comprising an advertisement component 502, configured for advertisement presentation. FIG. 5A illustrates an example 500 of the advertisement component 502 overlaying a content layer 506 over an advertisement layer 508. For example, the content layer 506 may correspond to an email application that may be populated with car dealership visit email content 504 (e.g., the email application may be hosted on a device associated with a user Dan that receive an email from user Colleen about visiting a car dealership). The advertisement layer 508 may comprise a promotional car event advertisement. The advertisement component 502 may overlay the content layer 506 over the advertisement layer 508, such as for display on the device (e.g., the content layer 506 may initially hide the advertisement layer 508, such as in FIG. 5D). For example, during display of the email application on the device, a position of the content layer 506 may be adjusted based upon scroll input of the car dealership visit email content 504 to reveal the advertising layer 508 or portion thereof (e.g., FIGS. 5E-5G).

In an example, the content layer 506 may be overlaid a set of advertisement layers. FIG. 5B illustrates an example 510 of the advertisement component 502 overlaying the content layer 506 over the advertisement layer 508 and over a second advertisement layer 512 comprising an Egypt vacation advertisement. In an example, the advertisement layer 508 is overlaid the second advertisement layer 512. During display of the email application on the device, a position of the content layer 506 may be adjusted based upon scroll input of the car dealership visit email content 504 to reveal the advertisement layer 508 or portion thereof. A position of the advertisement layer 508 may be adjusted based upon scroll input of the advertisement layer 508 to reveal the second advertisement layer 512 or portion thereof (e.g., as the user scrolls through the advertisement layer 508, an increasing amount of the second advertisement layer 512 may become revealed and/or a decreasing amount of the advertisement layer 508 may be displayed).

In an example, other interface elements and/or layers may be overlaid the advertisement layer 508, the second advertisement layer 512, and/or other advertisement layers not illustrated. FIG. 5C illustrates an example 520 of the advertisement component 502 overlaying a task interface 522 over the advertisement layer 508 and/or over the second advertisement layer 512. For example, the task interface 522 may comprise various email interface elements, such as a delete button, a send button, a save button, a new button, etc. During display of the email application on the device, a position of the content layer 506 may be adjusted based upon scroll input of the car dealership visit email content 504 to reveal the advertisement layer 508 or portion thereof, such that the revealed portion of the advertisement layer 508 may be displayed between the car dealership visit email content 504 and the task interface 522.

FIG. 5D illustrates an example 540 of a computing device 542, such as a mobile device, hosting the email application. The advertisement component 502 may display the content layer 506, comprising the car dealership visit email content 504, through the email application on the mobile device 542. In an example, the content layer 506 may be overlaid the advertisement layer 508 such that the content layer 506 hides the advertisement layer 508. FIG. 5E illustrates an example 550 of the advertisement component 502 identifying a first scroll input 552 of the car dealership visit email content 504 within the content layer 506. Responsive to identifying the first scroll input 552, the advertisement component 502 may adjust a position of the content layer 506 (e.g., the content layer 506 may be scrolled up, such that the text “Your Email” is scrolled beyond the top of the email application and is thus not visible) to reveal a first portion 554 of the advertisement layer 508 (e.g., a lower portion of the promotional car event advertisement may become visible). The first portion 554 of the advertisement layer 508 may be displayed as an advertisement preview through an advertisement presentation window 556 (e.g., an interface element, positioned after an ending edge of the content layer 506, defining a region through which advertisement layers or portions thereof are displayed). For example, the content layer 506 may be contracted to display a decreasing amount of the car dealership visit email content 504, and the advertisement presentation window 556 may be displayed and expanded to display an increasing amount of the advertisement layer 508 such as the first portion 554.

FIG. 5F illustrates an example 560 of the advertisement component 502 identifying a second scroll input 562 of the car dealership visit email content 504 within the content layer 506. Responsive to identifying the second scroll input 562, the advertisement component 502 may adjust a position of the content layer 506 (e.g., the content layer 506 may be scrolled up, such that the text “Hey Dan: What time do you want to meet at the car” is scrolled off the screen and is not visible) to reveal a second portion 564 of the advertisement layer 508 (e.g., a middle portion of the promotional car event advertisement may become visible). The second portion 564 and the first portion 554 the advertisement layer 508 may be displayed through the advertisement presentation window 556. For example, the content layer 506 may be further contracted to display a decreasing amount of the car dealership visit email content 504, and the advertisement presentation window 556 may be further expanded to display an increasing amount of the advertisement layer 508 such as the first portion 554 and the second portion 564.

FIG. 5G illustrates an example 570 of the advertisement component 502 identifying a third scroll input 572 of the car dealership visit email content 504 within the content layer 506 (e.g., the user may scroll past an advertisement reveal scroll threshold, such as by attempting to scroll past the car dealership visit email content 504). Responsive to identifying the third scroll input 572, the advertisement component 502 may adjust a position of the content layer 506 (e.g., the content layer 506 may be scrolled off the screen and become invisible) to reveal a third portion 574 of the advertisement layer 508 (e.g., a top portion of the promotional car event advertisement may become visible). The third portion 574, the second portion 564, and the first portion 554 the advertisement layer 508 (e.g., the entire advertisement layer 508) may be displayed through the advertisement presentation window 556. For example, the advertisement presentation window 556 may be further expanded into a full screen display of the advertisement layer 508.

FIG. 5H illustrates an example 580 of the advertisement component 502 identifying a scroll input 582 of the advertisement layer 508 (e.g., the user may attempt to scroll past the advertisement layer 508). Responsive to identifying the scroll input 582, the advertisement component 502 may contract display of the advertisement layer 508 through the advertisement presentation window 556 (e.g., a lower portion of the promotional car event advertisement may become invisible) and expand display of the second advertisement layer 512 through the advertisement presentation window 556 (e.g., a lower portion of the Egypt vacation advertisement may become visible). In this way, one or more advertisement layers may be displayed, such as according to a visual story telling ordering (e.g., a taxi advertisement layer, then a dinner advertisement layer, then a ice cream shop advertisement layer, and then a movie advertisement layer).

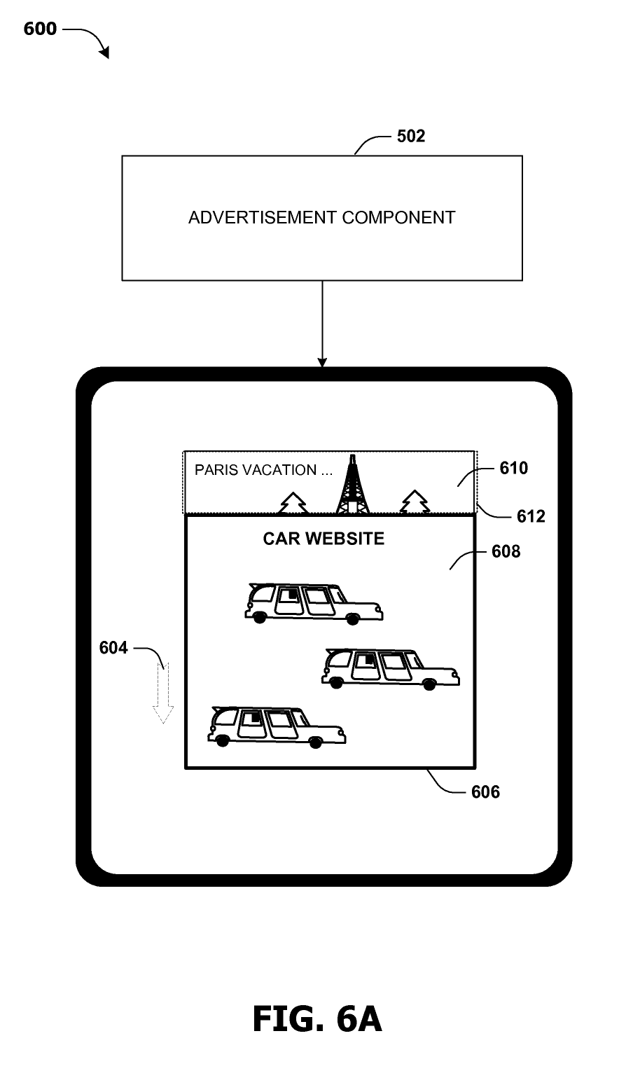

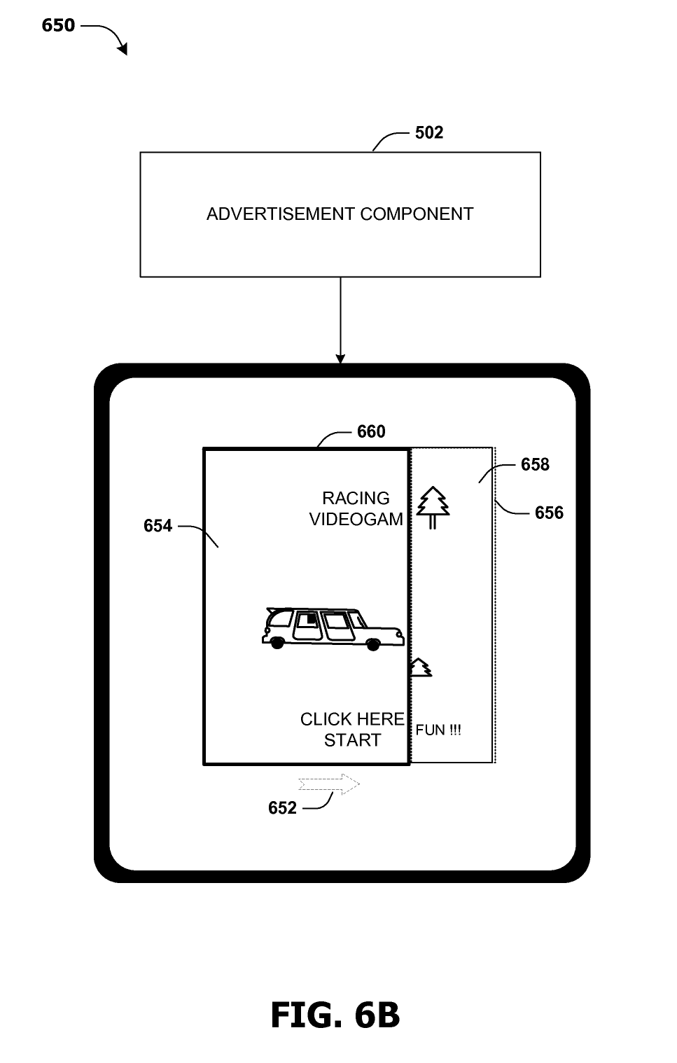

In an example, the advertisement component 502 may reveal advertisements layers from various directions based upon scroll input in any direction. FIG. 6A illustrates an example 600 of the advertisement component 502 identifying a scroll input 604 associated with website content 608 of a content layer 606 (e.g., a downward scroll through the website content 608). Responsive to the scroll input 604, the advertisement component 502 may adjust a position of a content layer 606 (e.g., the content layer 606 may be scrolled down, such that a lower portion of website content 608 is scrolled off the screen and is not visible) to reveal a first portion of an advertisement layer 610 (e.g., a top portion of a Paris vacation advertisement). The first portion of the advertisement layer 610 may be displayed as an advertisement preview through an advertisement presentation window 612. In an example, the advertisement presentation window 612 is positioned before a starting edge of the content layer 606. The content layer 606 may be contracted to display a decreasing amount of the website content 608, and the advertisement presentation window 612 may be displayed and expanded to display an increasing amount of the advertisement layer 610.

FIG. 6B illustrates an example 650 of the advertisement component 502 identifying a scroll input 652 associated with racing videogame content 654 of a content layer 660 (e.g., a right scroll through the racing videogame content 654). Responsive to the scroll input 652, the advertisement component 502 may adjust a position of a content layer 660 (e.g., the content layer 660 may be scrolled left, such that a left portion of racing videogame content 654 is scrolled off the screen and is not visible) to reveal a first portion of an advertisement layer 658 (e.g., a right portion of a camping advertisement). The first portion of the advertisement layer 658 may be displayed as an advertisement preview through an advertisement presentation window 656. In an example, the advertisement presentation window 656 is positioned after a right edge of the content layer 660. The content layer 660 may be contracted to display a decreasing amount of the racing videogame content 654, and the advertisement presentation window 656 may be displayed and expanded to display an increasing amount of the advertisement layer 658.

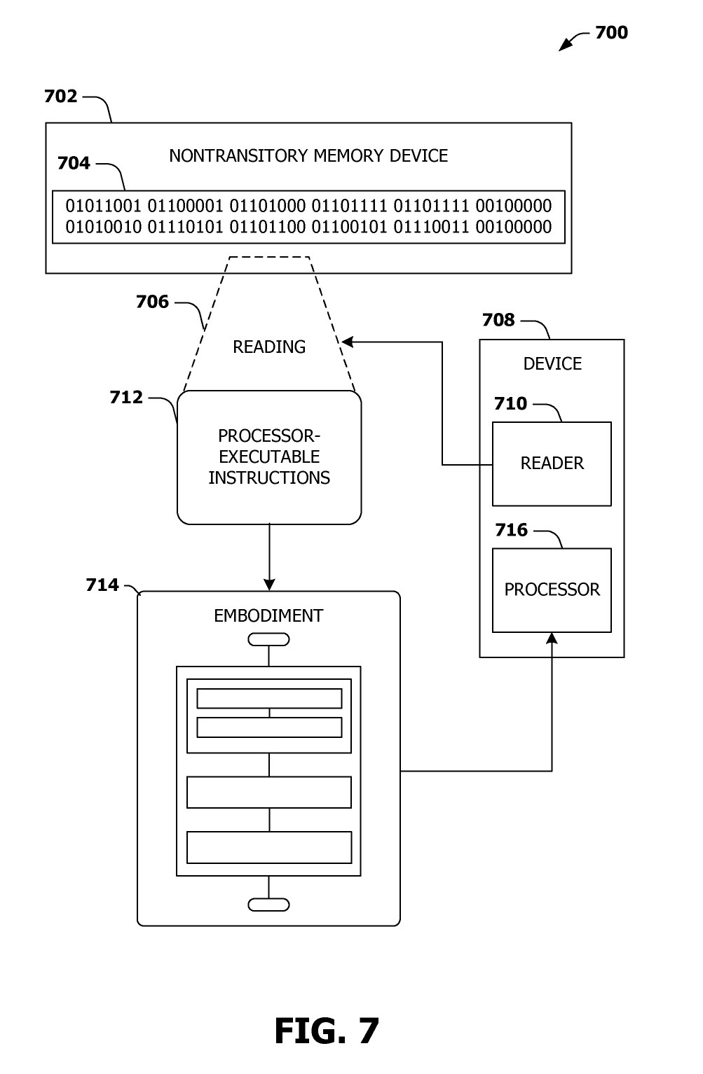

FIG. 7 is an illustration of a scenario 700 involving an exemplary nontransitory memory device 702. The nontransitory memory device 702 may comprise instructions that when executed perform at least some of the provisions herein. The nontransitory memory device may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The exemplary nontransitory memory device 702 stores computer-readable data 704 that, when subjected to reading 706 by a reader 710 of a device 708 (e.g., a read head of a hard disk drive, or a read operation invoked on a solid-state storage device), express processor-executable instructions 712. In some embodiments, the processor-executable instructions, when executed on a processor 716 of the device 708, are configured to perform a method, such as at least some of the exemplary method 400 of FIG. 4, for example. In some embodiments, the processor-executable instructions, when executed on the processor 716 of the device 708, are configured to implement a system, such as at least some of the exemplary system 501 of FIGS. 5A-5H, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method for advertisement presentation, comprising:
responsive to identifying a first scroll input of content within a content layer that is overlaid an advertisement layer, displaying an advertisement preview, through an advertisement presentation window, of the advertisement layer, the advertisement preview comprising a first portion of the advertisement layer; and
responsive to identifying a second scroll input of the content, displaying a second portion of the advertisement layer through the advertisement presentation window.

2. The method of claim 1, comprising:
mapping a first direction of scroll input of the content with expansion of the advertisement presentation window to display an increasing amount of the advertisement layer.

3. The method of claim 2, comprising:
mapping a second direction of scroll input of the content, different than the first direction, with contraction of the advertisement presentation window to display a decreasing amount of the advertisement layer.

4. The method of claim 1, the displaying an advertisement preview comprising:
adjusting a visual position of the content layer to reveal the first portion of the advertisement layer.

5. The method of claim 1, the displaying a second portion of the advertisement layer comprising:
adjusting a position of the content layer to reveal the second portion of the advertisement layer.

6. The method of claim 1, comprising:
responsive to identifying a scroll release input before an advertisement reveal scroll threshold is satisfied, contracting the advertisement presentation window to display a decreasing amount of the advertisement layer.

7. The method of claim 1, comprising:
responsive to identifying a scroll release input after an advertisement reveal scroll threshold is satisfied, displaying the advertisement layer through the advertisement presentation window.

8. The method of claim 7, comprising:
responsive to receiving dismiss input, contracting the advertisement presentation window to display a decreasing amount of the advertisement layer.

9. The method of claim 1, comprising:
displaying the advertisement presentation window after an ending edge of the content layer.

10. The method of claim 1, comprising:
displaying the advertisement presentation window before a starting edge of the content layer.

11. The method of claim 7, the advertisement layer overlaid a second advertisement layer, and the method comprising:
responsive to identifying a scroll input associated with the advertisement presentation layer:
contracting the display of the advertisement layer through the advertisement presentation window; and
expanding display of the second advertisement layer through the advertisement presentation window.

12. The method of claim 1, comprising:
generating a set of advertisement layers;
overlaying the content layer over the set of advertisement layers;
ordering advertisement layers within the set of advertising layers according to a visual story telling ordering; and
mapping a first direction of scroll input for the advertisement presentation window to sequentially reveal advertisement layers of the set of advertisement layers based upon the visual story telling ordering.

13. The method of claim 1, the displaying a second portion of the advertisement layer comprising:
providing at least one of sound or motion, through the advertisement presentation window, associated with the advertisement layer.

14. The method of claim 1, comprising:
displaying the advertisement presentation window between an ending edge of the content layer and a task interface associated with the content.

15. The method of claim 1, comprising:
displaying the advertisement presentation window between a starting edge of the content layer and a task interface associated with the content.

16. A system for advertisement presentation, comprising:
an advertisement component configured to:
generate an advertisement layer based upon one or more advertisements;
overlay a content layer, comprising content, over the advertisement layer; and
responsive to identifying a first scroll input of the content, adjust a position of the content layer to reveal a first portion of the advertisement layer through an advertisement presentation window.

17. The system of claim 16, the advertisement component configured to:
responsive to identifying a second scroll input of the content, adjust the position of the content layer to reveal a second portion of the advertisement layer through the advertisement presentation window.

18. The system of claim 16, the advertisement component configured to:
display the advertisement presentation window after an ending edge of the content layer.

19. The method of claim 16, the advertisement component configured to:
display the advertisement presentation window before a starting edge of the content layer.

20. A computer readable medium comprising instructions which when executed perform a method for advertisement presentation, comprising:
generating an advertisement layer based upon one or more advertisements;
overlaying a content layer, comprising content, over the advertisement layer;
responsive to identifying a first scroll input of the content, adjusting a position of the content layer to reveal a first portion of the advertisement layer through an advertisement presentation window; and
responsive to identifying a second scroll input of the content, adjusting the position of the content layer to reveal a second portion of the advertisement layer through the advertisement presentation window.
